(19) United States
(12) Patent Application Publication
(10) Pub. No.: US 2021/0063729 A1
(43) Pub. Date: Mar. 4, 2021

(54) OPTICAL DEVICE AND OPTICAL UNIT INCLUDING OPTICAL DEVICE

(71) Applicant: Murata Manufacturing Co., Ltd., Nagaokakyo-shi (JP)

(72) Inventors: Yasuhiro SHIMIZU, Nagaokakyo-shi (JP); Masaki NAGATA, Nagaokakyo-shi (JP); Kenji NISHIYAMA, Nagaokakyo-shi (JP); Yuuki ISHII, Nagaokakyo-shi (JP)

(21) Appl. No.: 17/096,102

(22) Filed: Nov. 12, 2020

Related U.S. Application Data
(63) Continuation of application No. PCT/JP2020/009610, filed on Mar. 6, 2020.

(30) Foreign Application Priority Data
May 16, 2019 (JP) 2019-093162

(51) Int. Cl. G02B 27/00; B08B 3/10; B08B 3/08; B08B 17/00; H05B 1/02

(52) U.S. Cl. CPC G02B 27/0006; B08B 3/10; H05B 1/0236; B08B 17/00; B08B 3/08

(57) ABSTRACT

An optical device includes a protective cover disposed in a field of view direction of an optical sensor, a casing that holds the protective cover, a temperature adjuster that adjusts the temperature of the protective cover, and a vibrating body that drives the protective cover to remove foreign matter adhering to a surface of the protective cover. The temperature adjuster adjusts the temperature of the protective cover so that the temperature increases from the periphery to the center of the protective cover.

### CROSS REFERENCE TO RELATED APPLICATIONS

This application claims the benefit of priority to Japanese Patent Application No. 2019-093162 filed on May 16, 2019 and is a Continuation Application of PCT Application No. PCT/JP2020/009610 filed on Mar. 6, 2020. The entire contents of each application are hereby incorporated herein by reference.

### BACKGROUND OF THE INVENTION

### 1. Field of the Invention

The present invention relates to an optical device and an optical unit that includes an optical device.

### 2. Description of the Related Art

In recent years, an optical unit equipped with an optical sensor, such as an imaging element, has been installed at the front or rear of a vehicle and the images obtained by the optical unit have been used to control safety devices and to perform automatic driving control. Since such an optical unit is often installed on the outside of the vehicle, foreign matter such as raindrops, mud, and dust may adhere to a transparent body (lens or protective cover) covering the outside of the optical unit. When such foreign matter adheres to the transparent body, the adhered foreign matter is reflected in the images obtained by the optical unit and clear images cannot be obtained.

Accordingly, in the optical unit disclosed in Japanese Unexamined Patent Application Publication No. 2019-11043, a housing to which the transparent body (optical element) is firmly attached is driven by a motor so as to rotate in order to remove foreign matter adhering to the surface of the transparent body. In the optical unit, the foreign matter is removed via the centrifugal action of the transparent body arising due to the transparent body being driven so as to rotate together with the housing.

However, in the optical unit disclosed in Japanese Unexamined Patent Application Publication No. 2019-11043, since the transparent body is driven so as to rotate around an axis at the center of the transparent body, a strong centrifugal action acts at the periphery of the transparent body away from the center of the transparent body and therefore foreign matter can be removed from the periphery of the transparent body, but it may not be possible to remove foreign matter from the center of the transparent body. In other words, in the optical unit disclosed in Japanese Unexamined Patent Application Publication No. 2019-11043, residue, such as water droplets, that could not be removed is generated at the center (center portion) of the transparent body and the field of view of the optical sensor is obstructed.

In addition, in the case of an optical unit that uses only a rotating mechanism or a vibrating mechanism to remove rain or water droplets adhering to the transparent body due to rainfall or a jet of cleaning liquid, residue may occur on the surface of the transparent body depending on the size of the droplets and the locations where the droplets are adhering to the transparent body, and it may not be possible to obtain accurate information regarding the surroundings due to the field of view of the optical sensor being obstructed.

### SUMMARY OF THE INVENTION

Preferred embodiments of the present invention provide optical devices and optical units each including an optical device and that are each capable of removing foreign matter adhering to a transparent body.

An optical device according to a preferred embodiment of the present invention includes a transparent body that is arranged in a field of view direction of an optical sensor; a casing that holds the transparent body; a temperature adjuster that adjusts the temperature of the transparent body; and a driver that drives the transparent body in order to remove foreign matter adhering to a surface of the transparent body. The temperature adjuster adjusts the temperature of the transparent body so that the temperature increases from the periphery to the center of the transparent body.

An optical unit according to a preferred embodiment of the present invention includes an optical sensor; and an optical device according to a preferred embodiment of the present invention.

According to preferred embodiments of the present invention, the temperature adjuster adjusts the temperature of the transparent body so that the temperature increases from the periphery to the center of the transparent body, and as a result, foreign matter adhering to the surface of the transparent body is moved to the periphery of the transparent body and removed and no residue is generated at the center of the transparent body.

The above and other elements, features, steps, characteristics and advantages of the present invention will become more apparent from the following detailed description of the preferred embodiments with reference to the attached drawings.

### BRIEF DESCRIPTION OF THE DRAWINGS

FIGS. 1A and 1B are schematic diagrams for describing the configuration of an optical unit according to preferred embodiment 1 of the present invention.

FIGS. 2A and 2B are plan views for describing the configuration of a linear member provided on a protective cover according to preferred embodiment 1 of the present invention.

FIG. 3 is a graph illustrating changes in the surface tension of water with respect to temperature.

FIGS. 4A and 4B are graphs illustrating differences in the surface tension of water with respect to a reference temperature.

FIG. 5 is a schematic diagram for describing the configuration of a modification of the optical unit according to preferred embodiment 1 of the present invention.

FIGS. 6A and 6B are plan views for describing configurations of a heater provided on a protective cover according to preferred embodiment 2 of the present invention.

FIGS. 7A and 7B are plan views for describing other configurations of a heater provided on a protective cover according to preferred embodiment 2 of the present invention.

FIGS. 8A and 8B are plan views illustrating a maximum displacement point when a protective cover according to preferred embodiment 3 of the present invention is made to vibrate.

FIG. 9 is a schematic diagram of a cleaning liquid discharger provided in an optical unit according to preferred embodiment 4 of the present invention.

FIG. 10 is a schematic diagram for describing the configuration of an optical unit according to a modification of a preferred embodiment of the present invention.

### DETAILED DESCRIPTION OF THE PREFERRED EMBODIMENTS

Hereafter, optical units according to preferred embodiments of the present invention will be described in detail while referring to the drawings. Note that the symbols in the drawings indicate identical or corresponding elements and portions.

### Preferred Embodiment 1

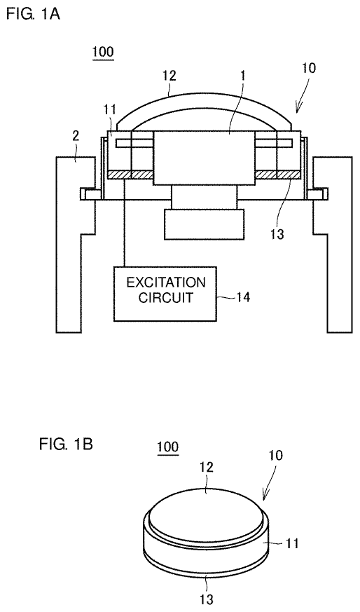

Hereafter, an optical unit according to a preferred embodiment 1 of the present invention will be described in detail with reference to the drawings. FIGS. 1A and 1B are schematic diagrams for describing the configuration of an optical unit 100 according to preferred embodiment 1. FIG. 1A is a sectional view of the optical unit 100 and FIG. 1B is an external view of the optical unit 100. The optical unit 100 is installed at the front or rear of a vehicle, for example, and is a unit that acquires information such as the shape, color, or temperature of an object, the distance to the object, and so forth. The optical unit 100 includes an optical sensor 1 to acquire information such as, for example, the shape, color, or temperature of an object, the distance to the object, and so forth, and an optical device 10 that includes an optical member and so forth that hold the optical sensor 1 and guide light to a sensor surface of the optical sensor 1. The optical unit 100 is installed in a vehicle or the like by fixing the optical device 10 to a support 2. Note that the place where the optical unit 100 is installed is not limited to a vehicle, and the optical unit 100 may be attached to other apparatuses, such as ships, aircraft, and the like, for example.

When the optical unit 100 is installed in a vehicle or the like and used outdoors, foreign matter such as raindrops, mud, and dust, for example, may adhere to a transparent body (lens or protective cover), which is arranged in a field of view direction of the optical sensor 1 and covers the outside of the optical unit 100. Accordingly, the optical device 10 is provided with a removal device to remove foreign matter adhering to the transparent body.

Specifically, the optical device 10 includes a casing 11, a transparent protective cover (transparent body) 12 provided on one surface of the casing 11, and a vibrating body 13 that vibrates the protective cover 12. The vibrating body 13 is connected to an excitation circuit 14 and makes the protective cover 12 vibrate based on a signal from the excitation circuit 14. The vibrating body 13 is a removal devices and removes foreign matter adhering to the protective cover 12 by vibrating the protective cover 12. The optical sensor 1 is provided inside from the protective cover 12 and is held by the casing 11.

The casing 11 has a cylindrical or a substantially cylindrical shape and is made of a metal or a synthetic resin, for example. The casing 11 may have another shape, such as a prism shape, for example. The protective cover 12 is provided at one end of the casing 11 and the vibrating body 13 is provided at the other end of the casing 11.

The vibrating body 13 is preferably, for example, a piezoelectric vibrator having a cylindrical or substantially cylindrical shape. The piezoelectric vibrator vibrates due to being polarized in the thickness direction, for example. The piezoelectric vibrator is preferably made of a PZT piezoelectric ceramic, for example. However, another piezoelectric ceramic, such as (K, Na)NbO₃, for example, may be used. In addition, a piezoelectric single crystal, such as LiTaO₃, for example, may be used.

The protective cover 12 has a dome shape that extends from the one end of the casing 11. In the present preferred embodiment, the dome shape is a hemispherical shape. The optical sensor 1 preferably has a field of view angle of about 170°, for example. However, the dome shape is not limited to being a hemispherical shape. The dome shape may have a shape obtained by connecting a cylinder to a hemisphere or may have a shape that is less curved than a hemisphere, for example. The protective cover 12 may also be a flat plate, for example. The entirety of the protective cover 12 is transparent so as to transmit at least the wavelengths of light that are the target of the optical sensor 1 therethrough. Therefore, the light that passes through the protective cover 12 may be visible or invisible light.

In the present preferred embodiment, the protective cover 12 is preferably made of glass, for example. However, the protective cover 12 is not limited to being made of glass and may instead be made of a resin, such as a transparent plastic, for example.

Alternatively, the protective cover 12 may be made of a transparent ceramic, for example. However, depending on the intended application, it is preferable to use tempered glass. This allows the strength to be increased. In the case of a resin, the protective cover 12 may be made of acrylic, cyclo-olefin, polycarbonate, polyester, or the like, for example. Furthermore, a coating layer made of DLC or the like, for example, may be provided on the surface of the protective cover 12 to increase strength, and a coating layer such as a hydrophilic film, a water-repellent film, a lipophilic film, an oil-repellent film, or the like, for example may be provided to enable antifouling of the surface and removal of raindrops.

The protective cover 12 may be a glass cover or may include an optical component such as a concave lens, a convex lens, or a flat lens, for example. There may be another optical component on the inner side of the protective cover 12. The method used to join the protective cover 12 and the casing 11 to each other is not particularly restricted. The protective cover 12 and the casing 11 may be joined to each other by using an adhesive, welding, fitting, press-fitting, or the like, for example.

The above-described optical sensor 1 is arranged inside the protective cover 12. The optical sensor 1 may be an image sensor, such as a complementary MOS (CMOS) or a charge-coupled device (CCD) image sensor, or a light detection and ranging (LiDAR) that uses a laser, for example. When an image sensor is used as the optical sensor 1, the optical sensor 1 captures an image of an external object that is to be imaged through the protective cover 12.

As removal device to remove foreign matter adhering to the protective cover, in addition to the vibrating body 13, there is a rotating mechanism to rotate the protective cover, for example. In the case where foreign matter adhering to the protective cover is to be removed using the rotating mechanism, when the protective cover is rotated, the amount of rotation at the periphery of the protective cover is large, whereas the amount of rotation at the center of the protective cover is small. In other words, since the centrifugal force acting at the center of the protective cover is smaller than the centrifugal action acting at the periphery of the protective cover, it is more difficult to clean off water droplets adhering to the protective cover at the center of the protective cover than at the periphery of the protective cover. Therefore, if a configuration is provided in which the optical axis of the optical sensor and the rotational axis of the protective cover coincide with each other, the center of the field of view of the optical sensor will coincide with the center of the protective cover and consequently water droplets remaining at the center of the protective cover will obstruct the field of view of the optical sensor. Although a case in which the center of the field of view of the optical sensor coincides with the center of the protective cover has been described, the center of the field of view of the optical sensor does not necessarily have to coincide with the center of the protective cover.

Accordingly, the optical device 10 according to preferred embodiment 1 is provided with a temperature adjuster that adjusts the temperature of the protective cover 12 so that the temperature of the protective cover 12 increases from the periphery of the protective cover 12 toward the center of the protective cover 12 so that no foreign matter (for example, water droplets or the like) remains at the center of the protective cover 12. In other words, the temperature adjuster generates a temperature gradient in which the temperature increases from the periphery of the protective cover 12 toward the center of the protective cover 12. When this temperature gradient is generated, the surface tension is smaller on the high-temperature side and the surface tension is larger on the low-temperature side. It is known that changes in surface tension due to a temperature gradient cause Marangoni convection in which water droplets move toward the lower temperature side. Water droplets adhering to the surface of the protective cover 12 can be effectively removed from the center of the protective cover 12 to the periphery of the protective cover 12 by utilizing this convection to shift the center of gravity inside each water droplet.

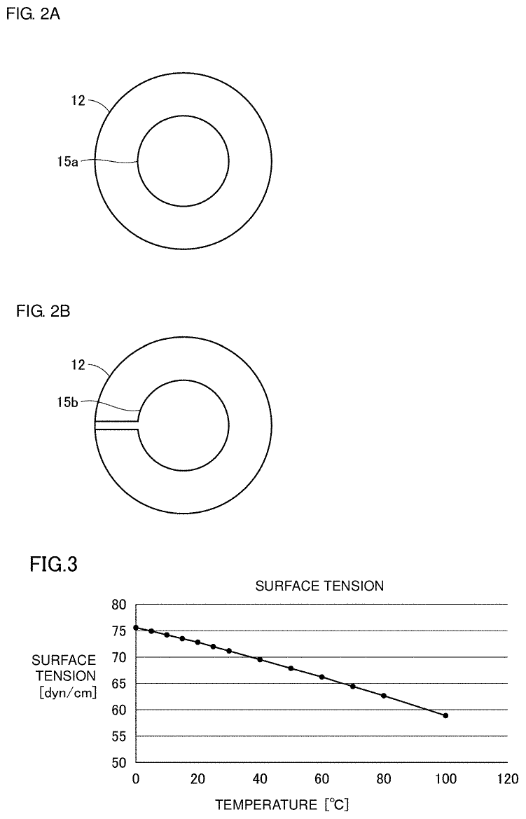

Specifically, as the temperature adjuster, a linear member having a higher thermal conductivity than the protective cover 12 is provided on the surface of the protective cover 12. FIGS. 2A and 2B are plan views for describing the configuration of a linear member provided on the protective cover 12 according to preferred embodiment 1. In FIG. 2A, a circular linear member 15a is provided at a position surrounding the center of the protective cover 12. In FIG. 2B, a keyhole-shaped linear member 15b is provided at a position surrounding the center of the protective cover 12.

The linear member 15a or 15b is provided between the center and the periphery of the protective cover 12 and the area of the protective cover 12 on the inside surrounded by the linear member 15a or 15b is smaller than the area of the protective cover 12 outside the linear member 15a or 15b. The linear members 15a and 15b are made of a material that conducts heat more readily than the protective cover 12 and radially transfer heat. Therefore, the heat from the linear members 15a and 15b spreads inwardly as well as outwardly in the protective cover 12. Since the area of the protective cover 12 on the inside surrounded by the linear member 15a or 15b is smaller than the area of the protective cover outside the linear member 15a or 15b, the portion of the protective cover 12 on the inside surrounded by the linear member 15a or 15b will become hotter than the portion of the protective cover 12 outside the linear member 15a or 15b.

Furthermore, because the area of the protective cover 12 becomes smaller with increasing proximity to the center inside the region surrounded by the linear member 15a or 15b, the heat transferred inwardly from the linear member 15a or 15b causes the protective cover 12 to become hotter with increasing proximity to the center of the protective cover 12. Thus, the temperature can be adjusted so that the temperature increases from the periphery of the protective cover 12 toward the center of the protective cover 12 by providing the protective cover 12 with the linear member 15a or 15b. In other words, the linear member 15a or 15b creates a temperature gradient in which the temperature increases from the periphery of the protective cover 12 toward the center of the protective cover 12 and the water droplets adhering to the surface of the protective cover 12 move towards the periphery of the protective cover 12 by this temperature gradient acting on the surface tension of the water droplets.

It is preferable that the linear members 15a and 15b are made of a material that readily conducts heat such as a transparent electrode material or any of various coating materials, for example. A temperature gradient can be created in the protective cover 12 and a hydrophilic or water-repellent function can be provided to the protective cover 12 by using a hydrophilic or water-repellent coating on the linear members 15a and 15b. When creating a temperature gradient using the linear member 15a or 15b, a larger temperature gradient can be created by using a material that does not readily conduct heat in a region other than the region where the linear member 15a or 15b is provided. In addition, the linear member 15a or 15b is provided on the inner surface of the protective cover 12 (the surface on the side near the optical sensor 1) or inside the protective cover 12. Furthermore, the linear member 15a or 15b is not limited to having a circular or keyhole shape as long as the area of the protective cover 12 on the inside surrounded by the linear member 15a or 15b is smaller than the area outside the linear member 15a or 15b. The linear member 15a or 15b may have a rectangular or polygonal shape, for example.

Next, the surface tension of water will be explained. FIG. 3 is a graph illustrating changes in the surface tension of water with respect to temperature. In FIG. 3, the horizontal axis represents temperature [° C.] and the vertical axis represents surface tension [dyn/cm]. As is clear from FIG. 3, the surface tension of water decreases as the temperature increases. For example, the surface tension of water is about 75 dyn/cm at about 0° C. and is about 60 dyn/cm at about 100° C.

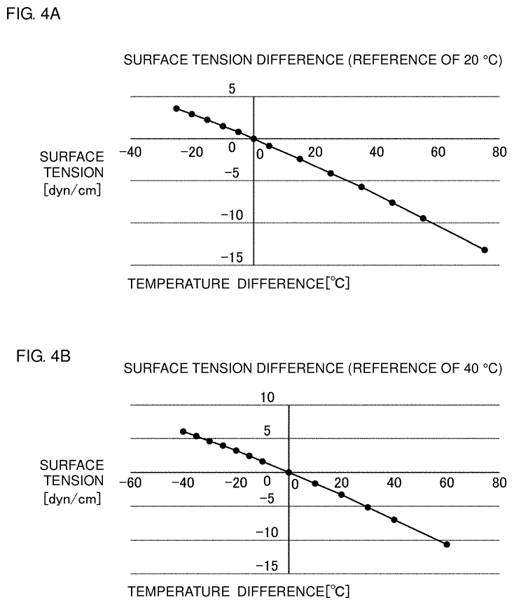

Next, the extent to which the surface tension of water varies with respect to a reference temperature will be explained. FIGS. 4A and 4B are graphs illustrating differences in the surface tension of water with respect to a reference temperature. In FIGS. 4A and 4B, the horizontal axis represents temperature difference [° C.] and the vertical axis represents surface tension difference [dyn/cm]. FIG. 4A illustrates changes in a surface tension difference with respect to a temperature difference when the reference temperature is about 20° C. and FIG. 4B illustrates changes in a surface tension difference with respect to a temperature difference when the reference temperature is about 40° C. When the reference temperature is about 20° C., a change of about 40° C. reduces the surface tension difference of water by about 6 dyn/cm, whereas when the reference temperature is about 40° C., a change of about 40° C. reduces the surface tension difference of water by about 7 dyn/cm.

The temperature adjuster creates a temperature gradient in which the temperature increases from the periphery of the protective cover 12 toward the center of the protective cover 12, but there are no particular limitations on the reference temperature used to generate the temperature gradient or on the temperature gradient itself, as illustrated in FIGS. 4A and 4B. In addition, as illustrated in FIG. 3, the surface tension difference can be increased by increasing the temperature gradient, and therefore water droplets can be more effectively moved to the periphery and removed.

In the optical unit 100 according to preferred embodiment 1, a configuration has been described in which the vibrating body 13 is provided and the protective cover 12 is vibrated by the vibrating body 13, but it is possible to remove foreign matter (for example, water droplets) adhering to the surface of the protective cover 12 by simply creating a temperature gradient using the temperature adjuster so that the temperature increases from the periphery to the center of the protective cover 12. In other words, the temperature adjuster can be used as a removal device to remove foreign matter adhering to the surface of the protective cover 12, and the optical unit 100 may be provided with only the temperature adjuster.

On the other hand, the vibrating body 13, which vibrates the protective cover, and the rotating mechanism, which rotates the protective cover 12, generate heat when driven, and the heat may be transferred to the protective cover 12 through the casing 11. This may cause a temperature gradient to be created in the protective cover 12 in which the periphery of the protective cover 12 becomes hotter due to heat transferred from the vibrating body 13 and the rotating mechanism and the center becomes cooler than the periphery of the protective cover 12. When the center of the protective cover 12 is cooler than the periphery of the protective cover 12, water droplets adhering to the surface of the protective cover 12 will move toward the center of the protective cover 12, the water droplets will accumulate at the center of the protective cover 12, and it will be more difficult to remove the water droplets. Therefore, in the case where the optical unit 100 is provided with the vibrating body 13 and the rotating mechanism, the temperature adjuster needs to create a larger temperature gradient in which the temperature increases to a greater degree from the periphery of the protective cover 12 toward the center of the protective cover 12.

For example, the temperature adjuster may be, for example, a planar member having a higher thermal conductivity than the protective cover 12, instead of a linear member. Such a planar member would be provided on a portion that includes the center of the protective cover 12. FIG. 5 is a schematic diagram for describing the configuration of a modification of the optical unit according to preferred embodiment 1. An optical unit 100a has the same or substantially the same configuration as the optical unit 100 illustrated in FIGS. 1A and 1B, except that the optical unit 100a is provided with a planar member 16 instead of a linear member, and the same or similar portions of the configuration are denoted by the same symbols and detailed description thereof is not repeated. An optical device 10a has the same or substantially the same configuration as the optical device 10 illustrated in FIGS. 1A and 1B, except that the optical device 10a is provided with the planar member 16 instead of a linear member, and the same or similar portions of the configuration are denoted by the same symbols and detailed description thereof is not repeated.

It is preferable that the planar member 16 is made of a material that readily conducts heat such as a transparent electrode material or any of various coating materials. A temperature gradient can be created in the protective cover 12 and a hydrophilic or water-repellent function can be provided to the protective cover 12 by using a hydrophilic or water-repellent coating on the planar member 16. When creating a temperature gradient using the planar member 16, a larger temperature gradient can be created by using a material that does not readily conduct heat in a region other than the region where the planar member 16 is provided.

In addition, the planar member 16 is provided on the inner surface of the protective cover 12 (the surface on the side near the optical sensor 1) or inside the protective cover 12. The planar member 16 is heated with heat from the side near the substrate, which includes the optical sensor 1, as illustrated in FIG. 5. On the other hand, the periphery of the protective cover 12 radiates heat via the casing 11. As a result, the planar member 16 is able to create a large temperature gradient in which the temperature increases more greatly from the periphery of the protective cover 12 towards the center of the protective cover 12. In particular, as illustrated in FIG. 5, by configuring the protective cover 12 to have a convex shape, heat can be retained in the portion of the protective cover 12 where the planar member 16 is provided on the inner surface of the protective cover 12 and the planar member 16 can be heated with heat from the side near the substrate, which includes the optical sensor 1, and a larger temperature gradient can be achieved.

Although the planar member 16 is provided only at the center of the protective cover 12 in FIG. 5, the planar member 16 may be provided over the entire or substantially the entire surface of the protective cover 12 and may be provided so as to have a higher density at the center of the protective cover 12 than at the periphery of the protective cover 12. The center of the protective cover 12, where the planar member 16 is provided so as to have a higher density, would be heated more than the periphery of the protective cover 12 where the planar member 16 is provided so as to have a lower density by the heat from side near the substrate including the optical sensor 1. Furthermore, a planar member having a lower thermal conductivity than the planar member 16 may be provided on the region of the protective cover 12 where the planar member 16 is not provided and the planar member may be provided over the entire or substantially the entire surface of the protective cover 12.

Furthermore, the casing 11 may be connected to a portion of the temperature adjuster so as to allow heat conduction therebetween. As illustrated in FIG. 2B, the keyhole-shaped linear member 15b is provided at a position so as to surround the center of the protective cover 12 and the straight-line portion of the keyhole shape extends to the periphery of the protective cover 12 and is connected to casing 11. This enables the linear member 15b, which is the temperature adjuster, to utilize heat from the casing (for example, heat from vibration of the vibrating body 13, heat from the rotating mechanism, and so forth).

As described above, the optical device 10 according to preferred embodiment 1 includes the protective cover 12 arranged in the field of view direction of the optical sensor 1, the casing 11 that holds the protective cover 12, and the temperature adjuster (for example, linear member 15a or 15b or planar member 16) that adjusts the temperature of the protective cover 12. The temperature adjuster adjusts the temperature of the protective cover 12 so that the temperature increases from the periphery of the protective cover 12 to the center of the protective cover 12.

Therefore, since the optical device 10 according to preferred embodiment 1 adjusts the temperature of the protective cover 12 so that the temperature increases from the periphery of the protective cover 12 to the center of the protective cover 12, foreign matter adhering to the surface of the protective cover 12 is moved to the periphery of the protective cover 12 and removed, and there is no residue at the center of the protective cover 12.

The temperature adjuster is a linear member having a higher thermal conductivity than the protective cover 12, the linear member is provided on the protective cover 12 and is shaped so as to surround the center of the protective cover 12, and the area of the protective cover 12 on the inside surrounded by the linear member may be smaller than the area of the protective cover 12 outside the linear member. Thus, a temperature gradient can be created in which the temperature increases from the periphery of the protective cover 12 to the center of the protective cover 12.

The temperature adjuster may be provided on the inner surface of the protective cover 12 or inside the protective cover 12. Thus, heat from the side near the substrate including the optical sensor 1 can be utilized.

There may be further provided a driver that performs driving so as to make the protective cover 12 rotate around an axis at the center of the field of view of the optical sensor 1 in order to remove foreign matter adhering to the surface of the protective cover 12. Thus, foreign matter adhering to the surface of the protective cover 12 can be removed by centrifugal action.

There may be further provided a driver that performs driving so as to make the protective cover 12 vibrate in order to remove foreign matter adhering to the surface of the protective cover 12. Thus, foreign matter adhering to the surface of the protective cover 12 can be removed by vibration of the protective cover 12.

The optical unit 100 or 100a includes the optical sensor and the optical device 10 described above. Thus, since the optical unit 100 or 100a adjusts the temperature of the protective cover 12 so that the temperature increases from the periphery of the protective cover 12 to the center of the protective cover 12, foreign matter adhering to the surface of the protective cover 12 is moved to the periphery of the protective cover 12 and removed, and there is no residue at the center of the protective cover 12.

Heat generated by the optical sensor 1 may be utilized in order to heat the linear member 15a or 15b or the planar member provided on the surface of the protective cover 12 and functioning as the temperature adjuster. In this case, since thermal design is performed so as to utilize heat transferred from the optical sensor 1 by the air inside the casing 11, the optical device does not consume additional power in order to create a temperature gradient in which the temperature increases from the periphery of the protective cover 12 to the center of the protective cover 12. Other than forming the linear member 15a or 15b or the planar member 16 by inserting, pasting, patterning, etc. a material that readily conducts heat on the surface of the protective cover 12, the thermal conductivity may be changed by changing the thickness of the protective cover 12 so as to create a temperature adjuster and a heat-retaining material may be provided in the protective cover 12.

### Preferred Embodiment 2

A configuration has been described for the optical device according to preferred embodiment 1 in which, for example, the linear member 15a or 15b or the planar member 16 is provided as a temperature adjuster that adjusts the temperature of the protective cover 12 and a temperature gradient is created in the protective cover 12. For the optical device according to the present preferred embodiment, a configuration will be described in which a temperature gradient is created by heating the protective cover 12 using a heater.

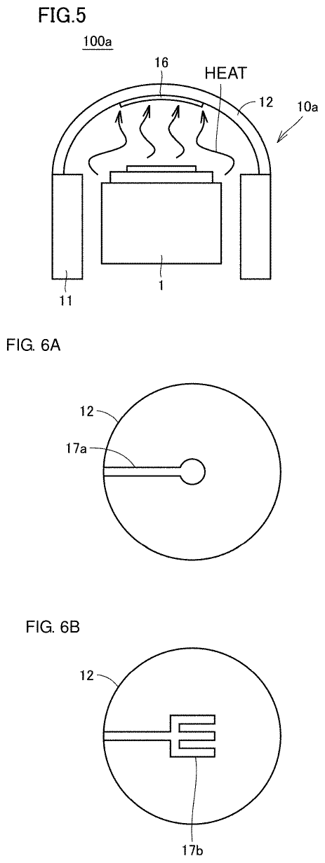

FIGS. 6A and 6B are plan views for describing configurations of a heater provided on a protective cover according to a preferred embodiment 2 of the present invention. The configuration of the optical unit according to preferred embodiment 2 is the same or substantially the same as that of the optical unit 100 illustrated in FIGS. 1A and 1B, except that a heater is provided instead of a linear member, and identical corresponding portions of the configuration are denoted by the same symbols and detailed description thereof is not repeated. In addition, the configuration of the optical device according to preferred embodiment 2 is the same or substantially the same as that of the optical device 10 illustrated in FIGS. 1A and 1B, except that a heater is provided instead of a linear member, and identical or corresponding portions of the configuration are denoted by the same symbols and detailed description thereof is not repeated.

In FIG. 6A, a ring-shaped heater 17a is provided at the center of the protective cover 12. In FIG. 6B, a comb-shaped heater 17b is provided at the center of the protective cover 12. The heater 17a or 17b is provided at the center of the protective cover 12 and power is supplied thereto by a wiring line extending from the center to the periphery. The heater 17a or 17b is a resistance heater and can be actively heated by supplying power thereto. Therefore, the center of the protective cover 12 is heated by the heat from the heater 17a or 17b, and as a result, the temperature of the protective cover 12 can be adjusted so that the temperature increases from the periphery of the protective cover 12 to the center of the protective cover 12. In other words, the heater 17a or 17b creates a temperature gradient in which the temperature increases from the periphery of the protective cover 12 towards the center of the protective cover 12, this temperature gradient acts on the surface tension of the water droplets adhering to the surface of the protective cover 12, and the water droplets can be moved toward the periphery of the protective cover 12.

The effect on optical design can be reduced by using a transparent electrode material for the heater 17a or 17b. The word “transparent” in the term “transparent electrode material” means that the material transmits light of the wavelengths that are the target of the optical sensor 1. Here, indium tin oxide, zinc oxide, tin oxide, titanium oxide, and a carbon material, such as graphene, for example, may preferably be used as the transparent electrode material. In addition, the heater 17a or 17b is provided on the inner surface of the protective cover 12 (the surface on the side near the optical sensor 1) or inside the protective cover 12. Furthermore, the heater 17a or 17b is not limited to having a ring or comb shape as long as the heater 17a or 17b is provided at the center of the protective cover 12. The heater 17a or 17b may have a rectangular or polygonal shape, for example.

When the heater 17a or 17b is provided on or in the protective cover 12, a circuit for heating the heater 17a or 17b, a temperature sensor for monitoring the temperature of the protective cover 12, and so forth may be provided.

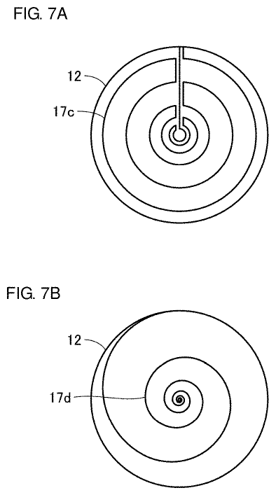

A configuration in which a heater is provided on the protective cover 12 is not limited to the configurations in which the heater is provided at the center of the protective cover 12 illustrated in FIGS. 6A and 6B. For example, the line-shaped conductive material of the heater may be arranged from the center to the periphery of the protective cover 12 with a wide spacing. FIGS. 7A and 7B are plan views for describing other configurations of a heater provided on a protective cover according to preferred embodiment 2. FIG. 7A illustrates an example of a heater 17c provided by arranging a plurality of concentric circular pieces of electrically conductive material from the center to the periphery of the protective cover 12, and FIG. 7B illustrates an example of a heater 17d provided by arranging an electrically conductive material in a spiral shape from the center to the periphery of the protective cover 12.

In the heaters 17c and 17d, the electrically conductive material is provided at a higher density at the center of the protective cover 12 than at the periphery of the protective cover 12 as is clear from FIGS. 7A and 7B. Thus, the heater 17c or 17d creates a temperature gradient in which the temperature increases from the periphery of the protective cover 12 towards the center of the protective cover 12, this temperature gradient acts on the surface tension of the water droplets adhering to the surface of the protective cover 12, and the water droplets can be moved toward the periphery of the protective cover 12. In the case where the optical device includes a rotating mechanism to rotate the protective cover 12, it is preferable that the direction of rotation of the rotating mechanism and the spiral direction of the electrically conductive material of the heater 17d be the same direction of rotation.

A resistance heater has been described as an example of a heater, but the heater is not limited to this example. For example, the heater may be a hot air heater (blower) that blows hot air toward the center of the protective cover 12. Any type of heater may be used as long as the heater is able to create a temperature gradient in which the temperature increases from the periphery to the center of the protective cover 12.

As described above, in the optical device according to preferred embodiment 2, the temperature adjuster is a heater. In particular, the heater is preferably, for example, a resistance heater made of a transparent electrode material on the surface of the protective cover 12. Thus, the heater actively heats the center of the protective cover 12 and is able to create a temperature gradient in which the temperature increases from the periphery to the center of the protective cover 12.

The resistance heater may be provided at a higher density at the center of the protective cover 12 than at the periphery of the protective cover 12. Thus, the heater can create a temperature gradient in which the temperature increases from the periphery of the protective cover 12 to the center of the protective cover 12.

### Preferred Embodiment 3

A configuration has been described for the optical device according to preferred embodiment 2 in which, for example, the heater 17a or 17b is provided and heated as a temperature adjuster to adjust the temperature of the protective cover 12 in order to create a temperature gradient in the protective cover 12. For the optical device according to the present preferred embodiment, a configuration will be described in which a temperature gradient is created in the protective cover 12 by heating the protective cover 12 without use of a heater.

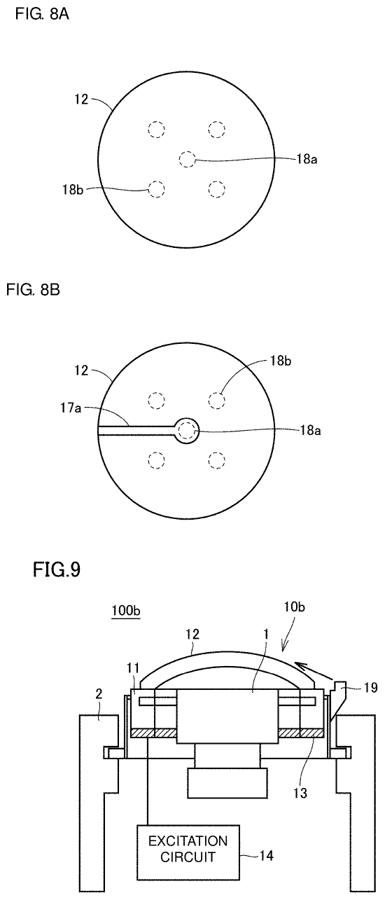

FIGS. 8A and 8B are plan views illustrating a maximum displacement point when a protective cover according to a preferred embodiment 3 of the present invention is vibrated. FIG. 8A illustrates a configuration in which the protective cover is heated using only vibrations and FIG. 8B illustrates a configuration in which the protective cover is heated using a combination of vibrations and a heater. The configuration of the optical unit according to preferred embodiment 3 is the same or substantially the same as that of the optical unit 100 illustrated in FIGS. 1A and 1B, except that the linear member is not provided, and identical or corresponding portions of the configuration are denoted by the same symbols and detailed description thereof is not repeated. In addition, the configuration of the optical device according to preferred embodiment 3 is the same or substantially the same as that of the optical device 10 illustrated in FIGS. 1A and 1B, except that the linear member is not provided, and identical or corresponding portions of the configuration are denoted by the same symbols and detailed description thereof is not repeated.

The optical device of preferred embodiment 3 also includes the vibrating body 13, and the protective cover 12 is vibrated by coupling with the vibration of the vibrating body 13, and the protective cover 12 is heated using the mechanical loss of the vibration. As described using FIG. 1B, in the optical device, the protective cover 12 is provided at one end of the casing 11 and the vibrating body 13 is provided at the other end of the casing 11. It is sufficient that the optical device includes the casing 11, the protective cover 12, and the vibrating body 13, and the order of these components is not particularly limited.

The vibrations of the protective cover 12 are excited by coupling between a width vibration and a higher-order width vibration of the vibrating body 13 or between a width vibration and a thickness longitudinal vibration of the vibrating body 13 so that a maximum displacement point 18a is located at the center of the protective cover 12, as illustrated in FIG. 8A. If the excitation frequency of the vibrating body 13 is, for example, about 500 kHz or higher and the protective cover 12 is vibrated at this excitation frequency or higher, heat can be more effectively generated through the mechanical loss of the vibration.

In the optical device, the protective cover 12 can be vibrated in a first vibration mode in which the vibration amplitude is larger at the outside of the protective cover 12 than at the center of the protective cover 12 and a second vibration mode in which the vibration amplitude is larger at the center of the protective cover 12 by making the vibrating body 13 vibrate. In other words, the first vibration mode is an atomization mode and is a vibration in which a maximum displacement point 18b of the protective cover 12 is located on a line segment drawn from the center of the protective cover 12, as illustrated in FIG. 8A. The maximum displacement point 18b is located at or near the center of the protective cover 12 on a line segment connecting the center and the periphery of the protective cover 12. On the other hand, the second vibration mode is a heating mode and the portion where the vibrational displacement is large is located at the center of the protective cover 12 (an anti-node of the vibration) and the portion where the vibrational displacement is small is located at the periphery of the protective cover 12 (the node of the vibration).

In the optical device, the maximum displacement point 18a of the protective cover 12 is vibrated and the protective cover 12 is heated utilizing the mechanical loss of the vibration by making the protective cover 12 vibrate in the second vibration mode (for example, about 500 kHz or higher). On the other hand, the optical device removes foreign matter by atomizing water droplets adhering to the surface of the protective cover 12 by making the maximum displacement point 18b of the protective cover 12 vibrate in the first vibration mode (for example, about 50 kHz or higher).

Since the optical device includes a heat-generating mechanism that makes the protective cover 12 vibrate in the second vibration mode (heating mode), the need for additional elements, such as a material that readily conducts heat to the protective cover 12, a transparent electrode, and so on is eliminated. As a result, in the optical device, a high degree of transparency can be maintained for the protective cover 12, clear information can be acquired by the optical sensor 1, and the structure on the protective cover 12 can be simplified. In addition, although it has been described that the optical device can make the protective cover 12 vibrate in either vibration mode of the first vibration mode (atomization mode) and the second vibration mode (heating mode), the optical device may instead be configured such that the protective cover 12 only vibrates in the second vibration mode (heating mode).

In FIG. 8B, in addition to the protective cover 12 being heated by the vibration of the protective cover 12, the optical device is provided with the heater 17a. Therefore, the optical device can heat the protective cover 12 using the heater 17a when it is not possible to create a sufficient temperature gradient in the protective cover 12 by heating the protective cover 12 by making the maximum displacement point 18a of the protective cover 12 vibrate.

As described above, in the optical device according to preferred embodiment 3, the excitation circuit 14 (driver) can drive the protective cover 12 so as to vibrate in the first vibration mode in which the vibration amplitude is greater at the outside of the protective cover 12 than at the center of the protective cover 12 and in the second vibration mode in which the vibration amplitude is greater at the center of the protective cover 12. The temperature adjuster heats the protective cover 12 by making the protective cover 12 vibrate in the second vibration mode using the excitation circuit 14. As a result, the optical device is able to create a temperature gradient in which the temperature increases from the periphery to the center of the protective cover 12 by heating a maximum displacement point 18 of the protective cover 12.

The optical device may further include a driver that drives the protective cover 12 so as to vibrate in a vibration mode in which the vibration amplitude is larger at the center of the protective cover 12, and the temperature adjuster may heat the protective cover 12 by making the protective cover 12 vibrate using the driver. The driver may be configured to such that the protective cover 12 only vibrates in the heating mode.

### Preferred Embodiment 4

It has been described that foreign matter adhering to the protective cover 12 is removed by making the protective cover vibrate using the vibrating body 13 in the optical device according to preferred embodiment 1. In addition to the vibrating body, the optical device according to the present preferred embodiment includes a configuration that discharges a cleaning liquid onto the surface of the protective cover.

FIG. 9 is a schematic diagram of a cleaning liquid discharger provided in an optical unit 100b according to a preferred embodiment 4 of the present invention. The configuration of the optical unit 100b according to preferred embodiment 4 is the same or substantially the same as that of the optical unit 100 illustrated in FIGS. 1A and 1B, except for the discharger being provided, and identical or corresponding portions of the configuration are denoted by the same symbols and detailed description thereof is not repeated. The configuration of an optical device 10b according to preferred embodiment 4 is the same or substantially the same as that of the optical device 10 illustrated in FIGS. 1A and 1B, except for the discharger being provided, and identical or corresponding portions of the configuration are denoted by the same symbols and detailed description thereof is not repeated.

The casing 11 is provided with a discharger 19 that discharges a cleaning liquid onto the protective cover 12, as illustrated in FIG. 9. The discharger 19 is supplied with a cleaning liquid from a cleaning liquid storage tank, which is not illustrated, and discharges the cleaning liquid through an opening onto the surface of the protective cover 12. The distal end of the opening of the discharger 19 is outside the field of view of the optical sensor 1 and the opening does not affect the optical sensor 1. In the present preferred embodiment, a configuration is illustrated in which one opening of the discharger 19 is provided in the casing 11, but alternatively, a plurality of openings of the discharger may be provided in the casing 11.

In the present preferred embodiment, a configuration has been described in which the discharger 19 provided in the optical unit is able to perform cleaning by discharging a cleaning liquid onto the surface of the protective cover 12, but alternatively, air may be discharged onto the surface of the protective cover 12 to perform cleaning, instead of the cleaning liquid. In other words, the discharger 19 discharges a cleaning liquid or air, which is a cleaning substance, onto the surface of the protective cover 12.

The discharger 19 discharges a cleaning liquid to remove foreign matter adhering to the surface of the protective cover 12, and the cleaning liquid may preferably include an alcohol, for example, in order to lower the freezing temperature of the cleaning liquid in consideration of cold weather use. Examples of the contained alcohol include methanol, ethanol, and so on. In addition, the cleaning liquid may include a surfactant. The discharger 19 can prevent rain from freezing by discharging the cleaning liquid onto the surface of the protective cover 12 during rainfall, and the optical device 10b can effectively remove water droplets by, for example, vibrating the protective cover 12.

When the discharger 19 discharges the cleaning liquid onto the surface of the protective cover 12 during rainfall, the concentration of the alcohol included in the cleaning liquid will fall due to the rain and the cleaning liquid mixing together, and the difference in surface tension will increase due to the temperature difference arising from the temperature gradient. For example, if the temperature adjuster (e.g., linear member 15a or 15b or planar member 16) creates a temperature gradient in which the temperature at the center of the protective cover 12 is about 25° C. and the temperature at the periphery of the protective cover 12 is about 20° C., the surface tension difference for a methanol solution is about 0.10 dyn/cm (=mN/m) or higher for a concentration of about 40 mass % or less.

Similarly, the surface tension difference for an ethanol solution is about 0.11 dyn/cm (=mN/m) or higher for a concentration of about 50 mass % or less. Since the centers of gravity of the water droplets move more easily the larger the surface tension difference is, the water droplets adhering to the surface of the protective cover 12 can be effectively removed.

As described above, the optical device 10b according to preferred embodiment 4 further includes the discharger 19 that discharges the cleaning substance onto the surface of the protective cover 12 and the discharger 19 discharges the cleaning liquid when foreign matter is adhering to the surface of the protective cover 12. Thus, the optical device 10b can remove foreign matter adhering to the surface of the protective cover 12 using the cleaning liquid discharged by the discharger 19.

The cleaning liquid discharger 19 may be shared with a mechanism to discharge a cleaning liquid onto the windscreen of a vehicle. By sharing the cleaning liquid discharger 19 with the mechanism to discharge the cleaning liquid onto the windshield of the vehicle, there is no need to provide a separate storage tank or discharging pump for the cleaning liquid and reductions in the cost and space required for the optical device 10b, which can discharge the cleaning liquid, can be achieved.

Furthermore, the optical device 10b according to preferred embodiment 4 can be combined with the configuration of another preferred embodiment. In addition, it has been described that, in addition to the vibrating body 13, the optical device 10b is provided with the discharger 19 that discharges the cleaning liquid onto the surface of the protective cover 12, but the discharger 19 may be combined with the rotating mechanism, instead of the vibrating body 13. The optical device 10b may be provided with only the discharger 19, without being provided with the vibrating body 13 and the rotating mechanism.

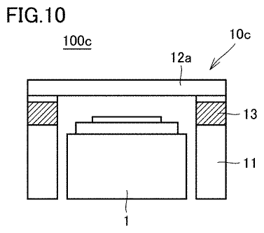

It has been described that the protective cover 12 has a dome shape in the optical devices according to the above-described preferred embodiments, but the protective cover 12 may instead have a plate shape. FIG. 10 is a schematic diagram for describing the configuration of an optical unit 100c according to a modification of a preferred embodiment of the present invention. The optical unit 100c includes the optical sensor 1, which is to acquire information such as, for example, the shape, color, temperature, and so forth of an object, the distance to the object and so forth, and the optical device 10c, which includes an optical member and so forth for holding the optical sensor 1 and guiding light to the sensor surface of the optical sensor 1. The optical device 10c includes the casing 11, a plate-shaped transparent protective cover 12a provided on one surface of the casing 11, and the vibrating body 13 that makes the protective cover 12a vibrate.

For the optical devices according to the above-described preferred embodiments, a configuration in which the linear member 15a or 15b or the like is provided on the protective cover 12 as a temperature adjuster that generates a temperature gradient in the protective cover 12 and heat transferred from the side near the substrate is utilized and a configuration in which a heating mechanism, such as the heater 17a, for example, is provided have been described. However, not limited to these configurations, the optical device may utilize heat radiated from peripheral portions (for example, the vibrating body 13 and the rotating mechanism).

In the optical devices according to the above-described preferred embodiments, a configuration has been described in which the heater 17a or the like is provided as a heating mechanism, and unlike heaters that are for melting snow or defrosting, such a heater can create a temperature gradient in which the temperature increases from the periphery to the center of the protective cover 12. Therefore, the optical device may use both a heating mechanism that creates a temperature gradient and a heating mechanism having a snow-melting function or a defrosting function. The optical device may use the heating mechanism that creates a temperature gradient to provide a snow-melting function or a defrosting function.

The optical units according to the above-described preferred embodiments may include a camera, a LiDAR, Rader, etc., for example.

The optical units according to the above-described preferred embodiments are not limited to optical units to be installed in vehicles, and can be similarly applied to optical units for applications where it is necessary to clean the protective cover 12, which is arranged in the field of view of the optical sensor.

In the optical units according to the above-described preferred embodiments, a vibrating body, a rotating mechanism, and a discharger have been described as removal devices to remove foreign matter adhering to the surface of the protective cover, but the removal device is not limited to these examples. The removal device may have any configuration as long as the removal device can remove foreign matter adhering to the surface of the protective cover and the removal device may be a mechanism that physically removes the foreign matter with a wiper, for example.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An optical device comprising:
a transparent body disposed in a field of view direction of an optical sensor;
a casing that holds the transparent body; and
a temperature adjuster that adjusts a temperature of the transparent body; wherein
the temperature adjuster adjusts the temperature of the transparent body so that the temperature increases from a periphery of the transparent body to a center of the transparent body.

2. The optical device according to claim 1, wherein
the temperature adjuster includes a linear body having a higher thermal conductivity than the transparent body;
the linear body is provided in or on the transparent body and surrounds the center of the transparent body; and
an area of the transparent body on an inside surrounded by the linear body is smaller than an area of the transparent body outside the linear body.

3. The optical device according to claim 1, wherein
the temperature adjuster includes a planar body having a higher thermal conductivity than the transparent body; and
the planar body is provided at a portion of the transparent body that includes the center of the transparent body.

4. The optical device according to claim 3, wherein the planar body is provided at a higher density at the center of the transparent body than at the periphery of the transparent body.

5. The optical device according to claim 2, wherein the casing is connected to a portion of the temperature adjuster to allow conduction of heat therebetween.

6. The optical device according to claim 1, wherein the temperature adjuster includes a heater.

7. The optical device according to claim 6, wherein the heater is a resistance heater including a transparent electrode material on a surface of the transparent body.

8. The optical device according to claim 7, wherein the resistance heater is provided at a higher density at the center of the transparent body than at the periphery of the transparent body.

9. The optical device according to claim 1, wherein the temperature adjuster is provided on an inner surface of the transparent body or inside the transparent body.

10. The optical device according to claim 1, further comprising a driver that performs driving to rotate the transparent body around an axis at a center of the field of view of the optical sensor in order to remove foreign matter adhering to a surface of the transparent body.

11. The optical device according to claim 1, further comprising a driver that performs driving to vibrate the transparent body to remove foreign matter adhering to a surface of the transparent body.

12. The optical device according to claim 11, wherein
the driver performs driving to vibrate the transparent body in a first vibration mode in which a vibration amplitude is larger at the periphery of the transparent body than at the center of the transparent body and a second vibration mode in which the vibration amplitude is larger at the center of the transparent body than at the periphery of the transparent; and
the temperature adjuster heats the transparent body by vibrating the transparent body in the second vibration mode using the driver.

13. The optical device according to claim 1, further comprising:
a driver that performs driving to vibrate the transparent body in a vibration mode in which a vibration amplitude is larger at the center of the transparent body than at the periphery of the transparent body; wherein
the temperature adjuster heats the transparent body by vibrating the transparent body using the driver.

14. The optical device according to claim 1, further comprising:
a discharger that discharges a cleaning substance onto a surface of the transparent body; wherein
the discharger discharges the cleaning substance when foreign matter is adhering to the surface of the transparent body.

15. The optical device according to claim 14, wherein the cleaning substance includes an alcohol.

16. An optical device comprising:
a transparent body disposed in a field of view direction of an optical sensor;
a casing that holds the transparent body; and
a temperature adjuster that adjusts the temperature of the transparent body; wherein
the temperature adjuster includes a linear body having a higher thermal conductivity than the transparent body;
the linear body is provided in or on the transparent body and surrounds the center of the transparent body; and
an area of the transparent body on an inside surrounded by the linear body is smaller than an area of the transparent body outside the linear body.

17. An optical device comprising:
a transparent body disposed in a field of view direction of an optical sensor;
a casing that holds the transparent body; and
a temperature adjuster that adjusts the temperature of the transparent body; wherein
the temperature adjuster includes a planar body having a higher thermal conductivity than the transparent body; and
the planar body is provided at a portion that includes a center of the transparent body.

18. An optical device comprising:
a transparent body disposed in a field of view direction of an optical sensor;
a casing that holds the transparent body; and
a temperature adjuster that adjusts the temperature of the transparent body; wherein
the temperature adjuster includes a heater.

19. An optical device comprising:
a transparent body disposed in a field of view direction of an optical sensor;
a casing that holds the transparent body;
a temperature adjuster that adjusts the temperature of the transparent body; and
a driver that performs driving to vibrate the transparent body in a vibration mode in which a vibration amplitude is larger at a center of the transparent body than at a periphery of the transparent body; wherein
the temperature adjuster heats the transparent body by vibrating the transparent body using the driver.

20. An optical unit comprising:
an optical sensor; and
the optical device according to claim 1.
